(19) United States
(12) Patent Application Publication
(10) Pub. No.: US 2004/0191448 A1
(43) Pub. Date: Sep. 30, 2004

(54) Supporting plate with inner bamboo sleeves

(76) Inventor: Wen Chang Wu, Yi Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/395,157

(22) Filed: Mar. 25, 2003

(51) Int. Cl. F16L 1/00

(52) U.S. Cl. 428/36.9; 428/72

(57) ABSTRACT

The present invention relates to a supporting plate with inner bamboo sleeves, which includes upper plywood, bottom plywood, and side wooden strips. Several bamboo sleeves are provided between the plywood, wherein the bamboo sleeve can be fulfilled in the inner space of the supporting plate between the plywood, The supporting plate with inner bamboo sleeves obtains better strength for supporting goods. The need of wood will be decreased that is utilized and economic.

### BACKGROUND OF THE INVENTION

The present invention relates to a supporting plate including the plywood and the inner bamboo sleeve, which provides a perfect strength for supporting goods.

It is known that a supporting plate being made of wood is widely used in different furniture, such as cabinet, table, or chair. Most conventional cabinet is made of real wood. Now, due to the policy of protecting woods around the world, a hollow supporting plate being made of plywood is provided to replace the real rigid wood. This prior supporting plate includes upper plywood and bottom plywood, wherein some wooden strips are provided irregularly therebetween. It will be found that the strength of this known plate is not enough at position without wooden strip. In some supporting plates, sawdust of wood is provided between the plywood. But the strength is still weak.

Accordingly, the primary object of the invention is to provide a supporting plate, which is provided with several bamboo sleeves between the plywood that obtains a better strength. Now the features and advantages of the present invention will be described in detail with reference to the accompanying drawings.

### BRIEF DESCRIPTION OF ACCOMPANYING DRAWINGS

FIG. 1 is a perspective view showing a supporting plate with inner bamboo sleeves according to the present invention.

FIG. 2 is a cross-sectional plan view showing parts of FIG. 1.

FIG. 3 is an exploded view of FIG. 1.

FIG. 4 is a top plan view showing the bamboo sleeves in the supporting plate according to the present invention.

FIG. 5 is a top plan view showing another modified embodiment similar to FIG. 4 according to the present invention.

FIG. 6 is a top plan view showing a further modified embodiment similar to FIG. 4 according to the present invention.

### DETAILED DESCRIPTION OF PREFERRED EMBODIMENTS

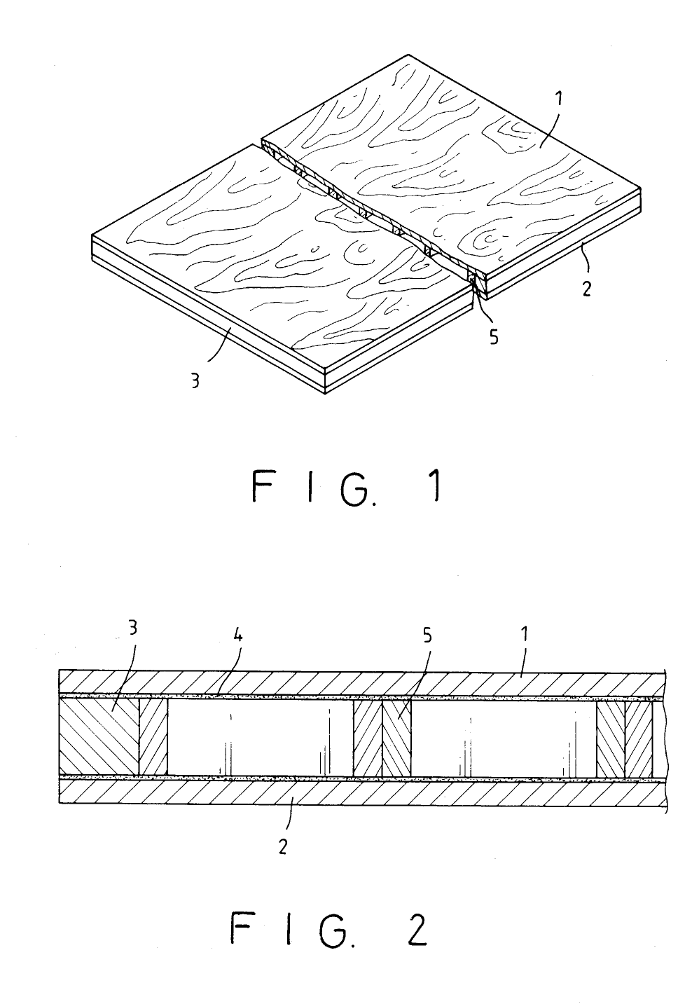

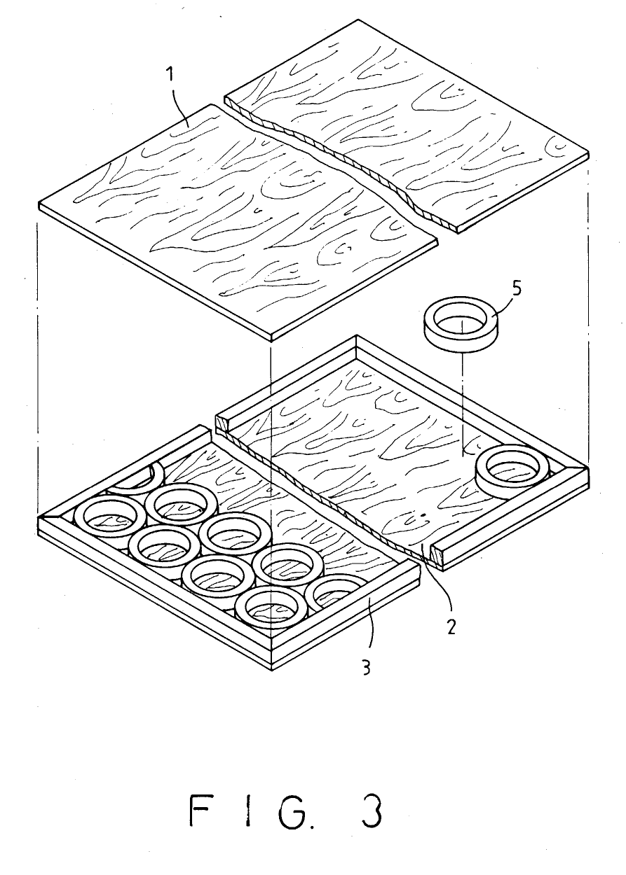

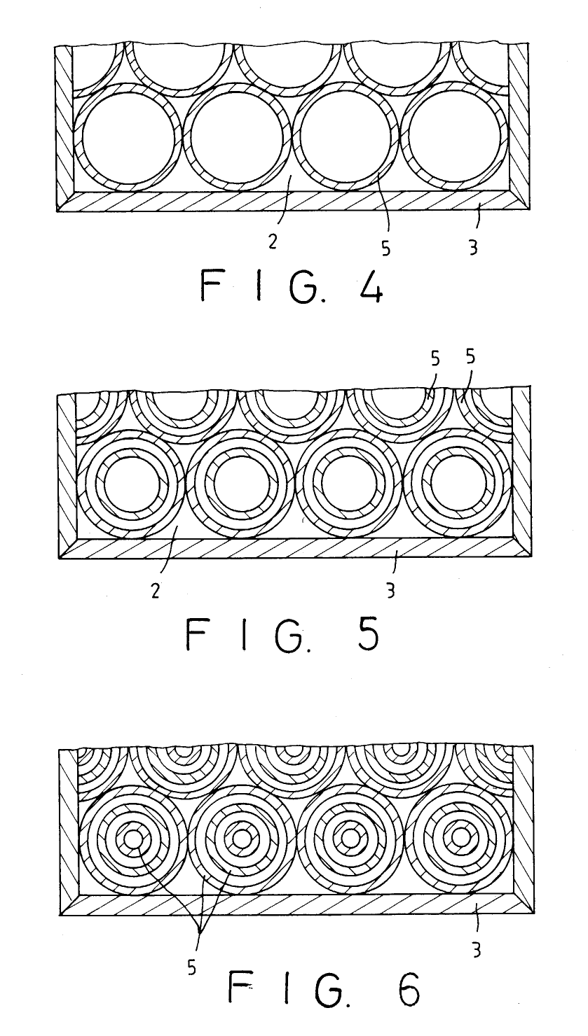

Please refer to FIGS. 1 to 3, the present invention relates to a supporting plate, which includes an upper plywood (1), a bottom plywood (3), and side wooden strips (3). The size of the supporting plate can be changed as desired. The characteristic of the present invention is to provide several bamboo sleeves (5) between the plywood (1), (2). The bamboo sleeve (5) is the same high and can be fulfilled in the inner space of the supporting plate. Each bamboo sleeve is combined together by glue (4) and will be assembled firmly with the supporting plate.

Since the bamboo grows fast, it can be the source without doubt. Moreover, the bamboo sleeve (5) can provide strong strength of supporting because of the vertical fiber. When many bamboo sleeves (5) are provided between the plywood (1) and (2) completely, as in FIG. 2, the supporting plate can obtain a better strength for supporting goods than ever.

As shown in FIGS. 5 and 6, the present invention can use bamboo sleeves (5) having various diameters, wherein a smaller sleeve can be mounted in a larger one. Under this assembly, the strength of the supporting plate will be more powerful.

Based on the same technique, it can be understood that the size or the high of the supporting plate can be changed easily by changing the size of the plywood and the number or the high of the bamboo sleeves. Accordingly, the present invention obviously achieves utility and improvement and should be allowed for patent.

What is claimed is:

1. A supporting plate with inner bamboo sleeves including an upper plywood, a bottom plywood, and side wooden strips, the characteristic is to provide several bamboo sleeves between the plywood, wherein the bamboo sleeve being the same high and being fulfilled in the inner space of the supporting plate between the plywood, and each bamboo sleeve being combined together by glue and being assembled firmly with the supporting plate.

2. The supporting plate with inner bamboo sleeves as claimed in claim 1, wherein the bamboo sleeves has various sizes, each of which has various diameters, while a smaller one is placed in a larger one that obtains a better strength of supporting.

3. The supporting plate with inner bamboo sleeves as claimed in claim 1, the high or the number can be changed to assemble a different size of the supporting plate, while the size of the plywood is also changed.
